(19) United States
(12) Patent Application Publication
(10) Pub. No.: US 2024/0286267 A1
(43) Pub. Date: Aug. 29, 2024

(54) Two Piece Camp Axe

(71) Applicant: Agawa Canyon Inc., Toronto (CA)

(72) Inventors: Graham N. Beck, Toronto (CA); Bradley Rothwell, Toronto (CA); Henry J. Samulski, Uxbridge (CA); Arthur H. Watson, Toronto (CA)

(21) Appl. No.: 18/587,797

(22) Filed: Feb. 26, 2024

Related U.S. Application Data
(60) Provisional application No. 63/448,221, filed on Feb. 24, 2023.

(51) Int. Cl. B25G 1/04; B26B 23/00

(52) U.S. Cl. CPC B25G 1/04; B26B 23/00

(57) ABSTRACT

A compact 2-piece axe comprises a first piece which is used as a hatchet, and with the connection of a second piece, which forms a handle extension, transforms the first piece, the hatchet, into an axe. The 2-piece axe of the invention when separated into the 2-pieces can be packed compactly, while still providing an axe which can be operated in two different axe modes, the first piece alone as a hatchet or the first piece with the handle extension attached as an axe. The axe of the invention can be and easily transformed from one axe mode to the other axe mode.

### BACKGROUND OF THE INVENTION

### Field

The invention is in the field of hatchets and axes and compact axes that can be easily carried.

### State of the Art

The bushcraft community loves the challenge of surviving and thriving in the woods. To this end, a vital skill is knowing what to bring and how to pack in order to live and travel successfully in the wild. A lightweight, compact pack is highly prized.

An axe is an essential tool in every bushcrafter's pack. The axe plays a vital role in felling trees, chopping and splitting wood, limbing trees and clearing brush, constructing shelters of wood, cutting kindling, woodcarving and many more activities. Unfortunately, no single axe can fulfill all these activities optimally. As a result, over the years, axe manufacturers have developed many varied sizes, weights, and styles of axes to address these various needs. Thus, when packing, a bushcrafter faces a common dilemma: should I bring two axes to meet my needs, in turn adding extra weight and space, or should I bring just one axe and which one (knowing that many axe activities will not be adequately performed)? As well, the bushcrafter must consider that using an axe for an activity that it was not specifically designed for can add an extra risk of injury in a setting where injuries need to be avoided.

Various foldable hatchet and axe configurations have been proposed to provide a more easily packed and carried axe, see for example U.S. Pat. Nos. 1,614,949, 5,771,588, and 6,792,683. However, these foldable hatches and axes have short comings with respect to packability, weight, ease-of-unfolding, and ability to perform the variety of jobs desired. Also there have been a number of multi-purpose tools proposed that provide a tool handle with a number of attachable tool heads which can include axe heads, see for example Published Patent Application Nos. 2005/0015885, 2010/0263133, 2012/0098282, and 2021/0008705. However, the multi-purpose tools which provide separable handles which can be attached to a number of different tool heads do not have handles specifically designed for use with axe heads and therefore have short comings when being used as axes. Also such handles and tools have short comings with respect to packability, weight, and ease of packing.

There remains a need for an axe that can perform as either a hatchet or an axe and that can be easily packed and carried.

### SUMMARY OF THE INVENTION

The present invention provides a compact 2-piece axe comprising a first piece which is used as a hatchet, and with the connection of the second piece, which forms a handle extension, transforms the first piece into an axe. The 2-piece axe of the invention helps to overcome the camper's axe packing dilemma by providing a 2-piece camp axe that can be packed compactly, operated in two different axe modes, and is easily transformed from one axe mode to the other.

In the first axe mode, the first of the two pieces serves as a stand alone, short-handled axe that functions as a hatchet. This hatchet has been optimally designed to provide superior performance and control for activities such as woodcarvings, wood-shavings, shelter building, hammering, and rendering of kindling wood. Within the bushcraft community, such a hatchet is commonly referred to as a camp hatchet.

In the second axe mode, the second piece, which is a handle extension, is attached to the bottom of the camp hatchet handle. This now creates a longer handled axe which functions as a longer-handled axe. This longer-handled axe has been designed to offer excellent all-purpose camp performance and power for activities such as brush clearing, limbing, felling small tress, chopping and splitting wood. An axe designed for the above said purposes is often called a forest axe.

The end of the hatchet handle away from the axe head has a coupler for attaching the extension handle. An attachment end of the extension handle also includes a coupler which is configured to mate with the coupler on the end of the hatchet handle. The couplers will normally include latch components which interact to latch the handles together when joined so they do not come apart during use of the longer handled axe. The hatchet handle coupler may include a receiving opening in the attachment end of the hatchet handle while the extension handle attachment end coupler may include a projection which is received in the opening in the hatchet handle attachment end. The latches may include a pair of spring wire clips extending from the attachment end of the extension handle and configured to mate with spring wire clip latches at the hatchet handle end.

Since a hatchet and an axe are designed to perform different functions, the axe head for a hatchet and the axe head for an axe are designed differently. With the current invention the same axe head is used both for the hatchet and for the axe. This requires an axe head to be designed to include features of both the traditional hatchet head and traditional axe head. The axe head of the invention includes a bit having a double bevel. The double bevel provides an initial cutting edge bevel extending along the edge of the bit and which is suitable for hatchet tasks and which transitions into a second bevel forming a splitting portion suitable for axe tasks. The axe head beard drops low as in a hatchet. The axe head of the invention is heaver than the traditional hatchet head but still light enough to easily perform the functions of a hatchet but heavy enough to function well as forest axe. An important feature of the axe head provides beveled relief cut-outs in the cheeks near the toe and heel of the axe head. These cut-outs lower the overall weight of the axe head and reduce binding when using the axe for splitting wood.

Perhaps the most important feature of the present invention is the ease with which the user can routinely transform the camp hatchet into a rugged, reliable, high-performance forest axe. When disassembled into two pieces, the two pieces are each compact—the size of a hatchet and the size of a small handle—and can easily fit inside most backpacks.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a side elevation view of an example embodiment of a two piece axe of the invention showing the two pieces of the two piece axe separated;

FIG. 2 is a perspective view of the example embodiment of the two piece axe of FIG. 1 again showing the two pieces separated;

FIG. 3 is an enlarged view of the axe of FIG. 2 showing the attachment ends of the handles encircled by the line 3-3;

FIG. 4 is a perspective view of an axe similar to that shown in FIG. 2, but showing the two handle pieces joined together;

FIG. 5 is a perspective view of the axe of FIG. 4 showing the two handle pieces separated;

FIG. 6 is an enlarged view of the handle pieces of FIG. 4 joined together and as encircled by the line 6-6;

FIG. 7 is an enlarged view of the handle pieces of FIG. 5 separated and as encircled by the line 7-7;

FIG. 8 is a side elevation view similar to that of FIG. 1 but showing the two handle piece joined together but not latched together;

FIG. 9 is a view similar to that of FIG. 8 showing the two handle piece joined together and latched together;

FIG. 10 is an enlarged view of the handle pieces of FIG. 8 joined together but not latched together and as encircled by the line 10-10 in FIG. 8;

FIG. 11 is an enlarged view of the handle pieces of FIG. 9 joined together and latched together and as encircled by the line 11-11 in FIG. 9;

FIG. 12 is a top view of the two piece axe of FIG. 9;

FIG. 13 is a bottom view of the two piece axe of FIG. 9;

FIG. 14 is an front view of the two piece axe of FIG. 9;

FIG. 15 is a vertical section through the axe of FIG. 14 taken on the line 15-15 of FIG. 14;

FIGS. 16 A-16 F are views of the wire spring clips used as latching components for the two handle pieces.

FIG. 17 is a side view of two handle pieces of the invention in locked together position using wire spring clips and showing use of an unlocking tool of the invention in the process of unlocking the handle pieces;

FIG. 18 is an elevation view of the unlocking tool; and

FIG. 19 is a perspective view of the unlocking tool.

### DETAILED DESCRIPTION OF THE ILLUSTRATED EMBODIMENT

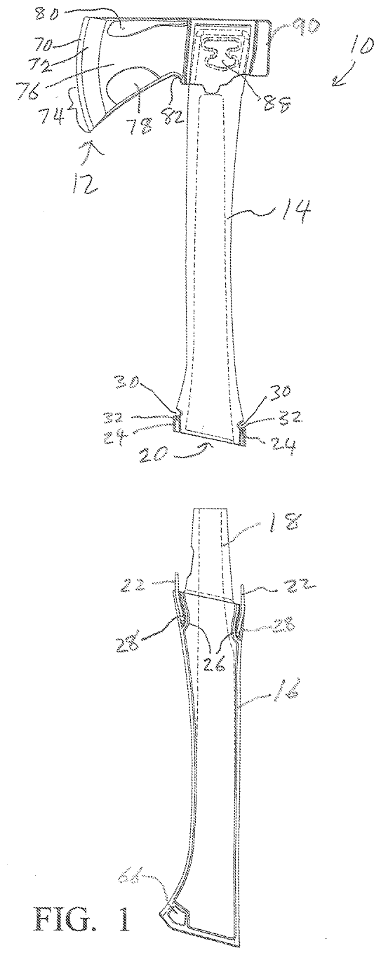

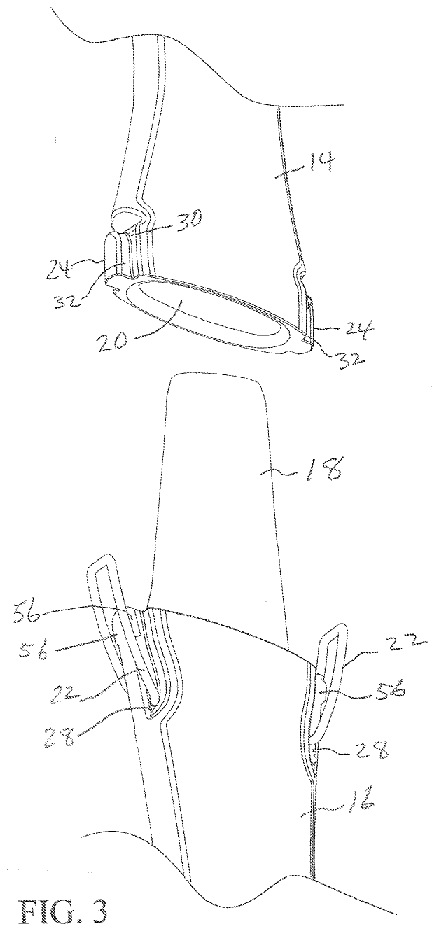

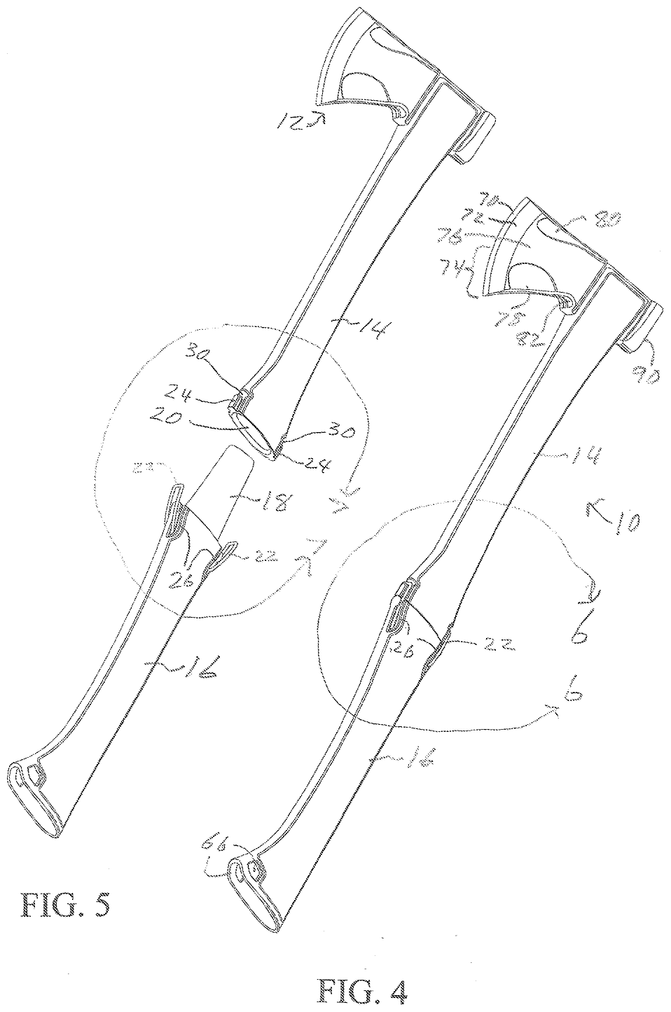

As shown in the figures, the invention is a two piece axe wherein the first piece 10 forms a hatchet, often referred to as a camp hatchet, having an axe head 12 and a relatively short hatchet handle 14, in the order of about fourteen inches, attached to the axe head 12. The second piece 16 is a handle extension which is removably secured to the end of the hatchet handle 14 to together form a longer axe handle for the axe head 12. FIGS. 1, 2, 3, 5, and 7 show the first piece forming the hatchet 10 separated from the second piece 16, the handle extension. When separated, the first piece 10 is used as a hatchet without the second piece 16. FIGS. 4,6,8,9,10, and 11 show the second piece, the handle extension 16, attached to the first piece 10 to form a longer handled axe often referred to as a forest axe.

In contemplating a compact, camp axe that could function as a camp hatchet and then transform into a forest axe or visa versa, the inventors initially considered various hinged joint designs where part of the axe handle folded or telescoped into the camp hatchet. These configurations were found to be inadequate in meeting the very demanding design requirements of a camp hatchet and a forest axe. In the end, a two-piece design resembling a tight-fitting rod within a thick-walled tube connection was selected as the best approach to meeting the challenging design requirements that include: 1) provide an easy and reliable connection (engagement/disengagement) under all outdoor conditions (heat, freezing, humidity, dirt); 2) provide equivalent strength and rigidity as achieved with a solid hardwood handle under all expected applied forces (bending, axial, torsional); 3) provide a simple yet safe attachment mechanism between the two handle members and 4) provide handle shapes that are ergonomically pleasing when used either as a camp hatchet or as a forest axe.

In the illustrated embodiment, the axe handle connection consists of the handle extension 16 with a tapered post or plug 18 having an oval cross section that is inserted into the hollow bottom or socket 20 of the hatchet handle. The hatchet handle's interior wall surface (socket) mirror-mates with the surface of the tapered plug and, when fully inserted, produces a push fit between the hatchet handle 14 and the extension handle 16 which prevents any rotational movement between the two handles. The push fit connection is secured in place for proper and safe axe operation when two wire clips 22 located at opposite sides of the extension handle are locked into place over clip latch latches 24 on the hatchet handle. The opposite sides of the handle each having a wire clip and a wire clip latch are the throat and belly sides of the axe handle shown.

The requirement for securing the axe handle connection is stringent. It must: 1) be simple to engage and disengage; 2) be of low profile offering minimal tactile sensation while running a loose hand over the axe handle connection; 3) provide a compressive force between the hatchet handle and the extension handle when locked in place; 4) be convenient and rugged (not easily damaged), and 5) offer safety through redundancy and an obvious warning when an axe handle connection is ‘not fit for use’.

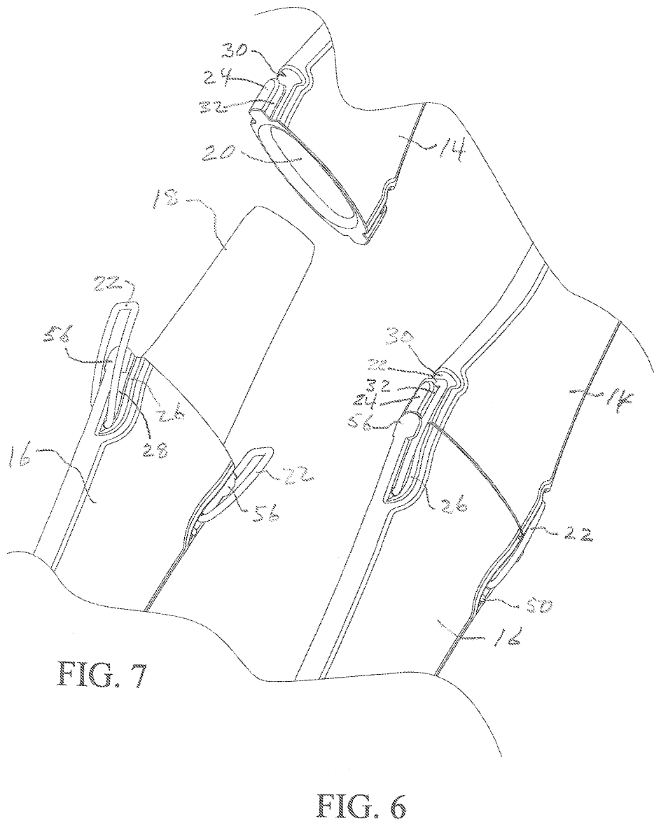

After experimenting with many different attachment designs, it was found that a design incorporating two steel wire clips 22 located on opposite sides of the extension handle when latched over corresponding latches 24 on the hatchet handle 14 provided the best solution to the matter of securing the axe handle connection. To accommodate the wire clips 22 and attach them to the extension handle 16, recesses 26 are provided along the opposite throat and belly sides of the extension handle 16 at the connection end of the extension handle leaving a rib portion 28 on the opposite throat and belly sides of the attachment end of the extension handle. These recesses 26 provide space for attachment of the wire clips to the ribs 28 without extending beyond any sides of the extension handle. Recesses 30 are provided on opposite throat and belly side portions of the attachment end of the hatchet handle 14 to form the latches 24 in the recesses 30. The recesses 30 provide space around the top and sides of the latches 24 so the clips 22 can be rotated to latched position with the tops of the clips moved over the tops of latches 24 into a latch groove 32 at the top of latch 24, see FIGS. 6, 9, and 11. The upper end of the clips 22 will then be positioned in the recesses 30 without extending beyond any sides of the hatchet handle 14. The wire clips are custom formed from hardened, stainless, spring steel and the wire has a relatively small diameter of about 0.095 to 0.105 inches. With this relatively small wire diameter, when the wire clips 22 are in latched position with the portion of the wire clip received into grooves 32 in catches 24, the clips 22 offers negligible protrusion from the handle's surface, thus satisfying the low-profile requirement. Two clips, one on either side of the handle, are used. The two clips provide balanced latching tension on each side of the handle connection and also provide extra strength to hold the connection together under various forest axe striking conditions, such as over strike, missed hits, side strikes, and hammering hits.

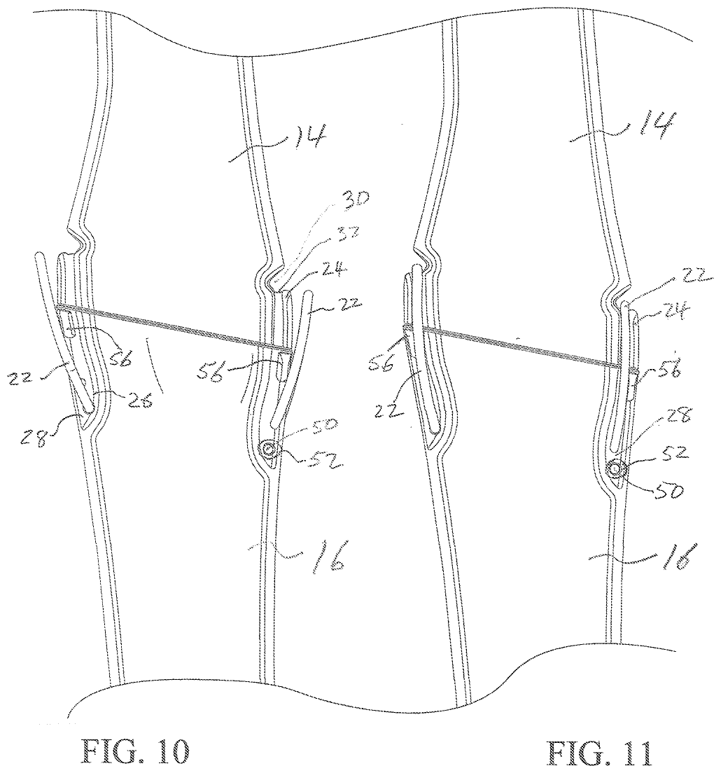

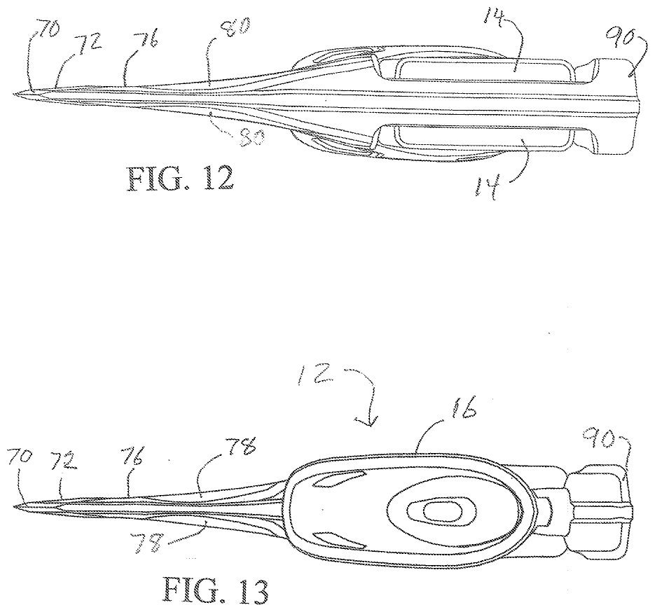

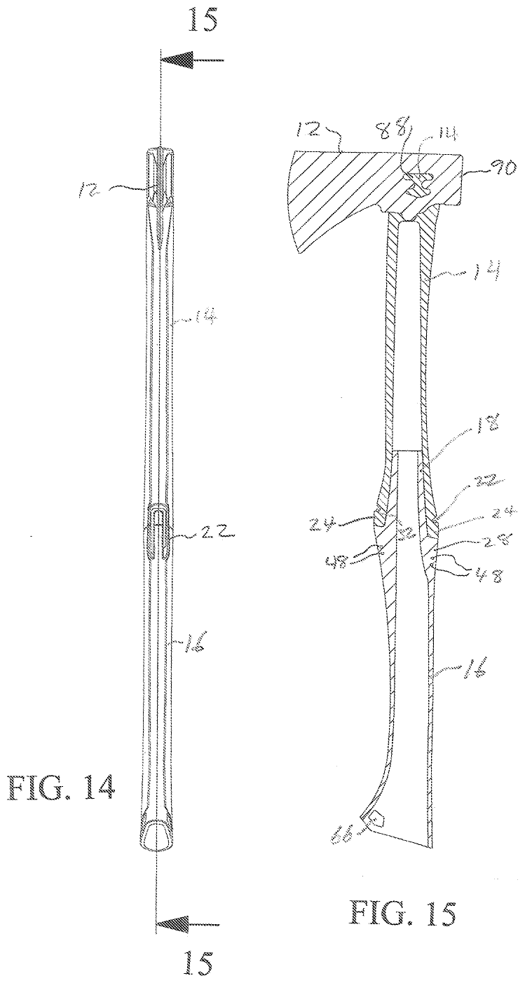

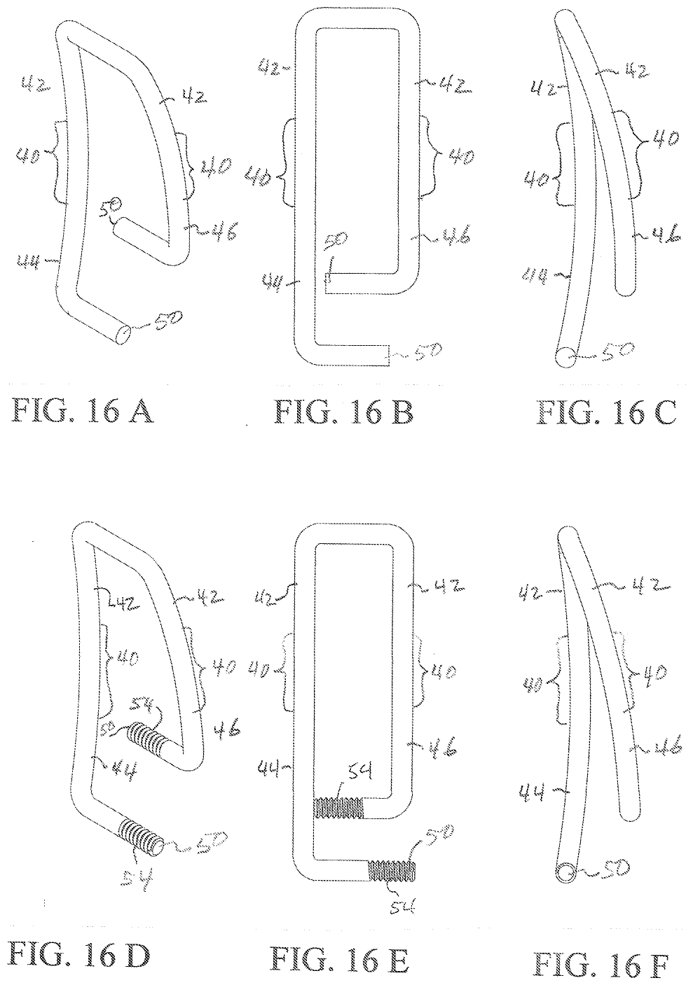

The shape of the wire clips, see FIGS. 16 A through 16 F, meet several important requirements. First, a precise camber (or bend) of equal radius is formed in the middle portion 40, along each leg of the wire clip 22. The portions 42 of the legs above the camber portions 40 are straight as are the lower portions 44 and 46. The camber portions 40 serve two purposes: 1) they allow the spring wire to initially flex-over the latches 24 and into the latch grooves 32 on the hatchet handle thus providing a lock mechanism; 2) then, once latched, they will want to return to their original shape due to the springe wire's ‘memory’, thus providing a constant compression force on the handle connection. Second, one clip leg is longer than the other clip leg, i.e., the clip leg lower portion 44 is longer than the clip leg lower portion 46. This allows the clip installation holes 48, FIG. 15, through the extension handle ribs 28 to be suitably separated and to extend fully through the ribs 28 so that the wire clip ends 50 which enter the holes 48 may extend the full width of the extension handle rib 28. This helps in preventing the wire clip from becoming dislodged. Additionally, the full-width holes 48 allow each wire end 50 to protrude from the extension handle ribs 28 permitting the attachment of a nut or some other fastener 52, FIGS. 10 and 11, to be attached to the end of each wire extending from the holes 48 to further prevent the wire clips from dislodgement. Threads 54 may be provided at the wire ends 50 to secure such nuts or other fastener. Finally, one leg of the spring wire is formed off-set from the other leg. When the spring wire legs are inserted into their placement holes on the extension handle, the ‘spring effect’ of the formed leg off-set results in the wire clip receiving a constant force inward towards the handle. This inward force assists in keeping the wire clips in their latched positions. As well, this inward force also keeps the wire clips stiff in an upwards position such as shown in the Figures when the extension handle is removed from the hatchet handle and helps minimize wire clip damage in handling. Given the requirement for a strong, hardened, spring steel, the presently preferred material for the wire clip is 17-7 SS stainless spring steel having a diameter of 0.095-0.105 inches.

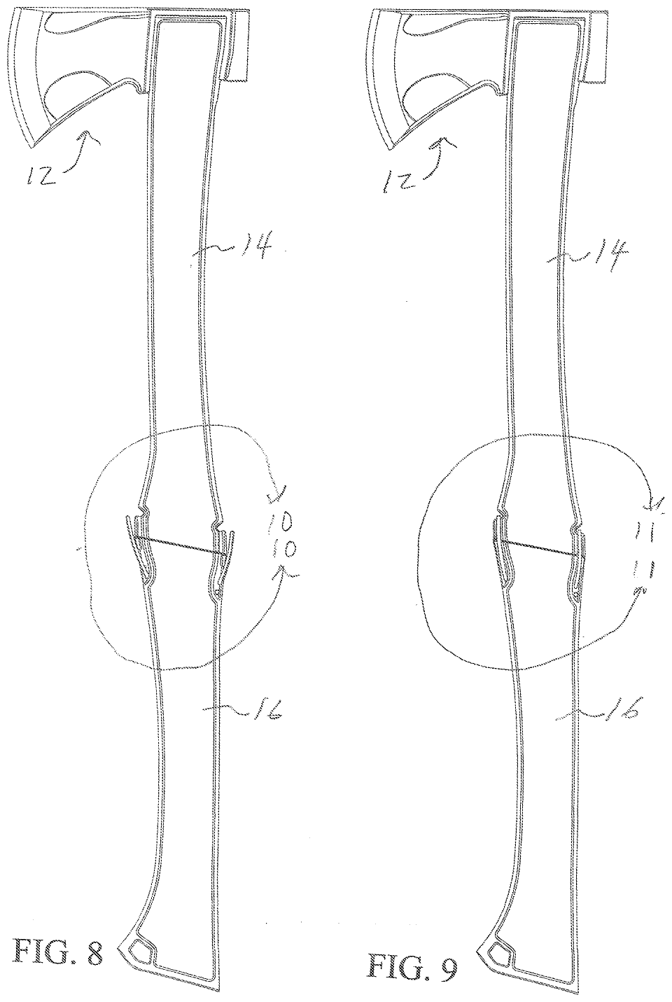

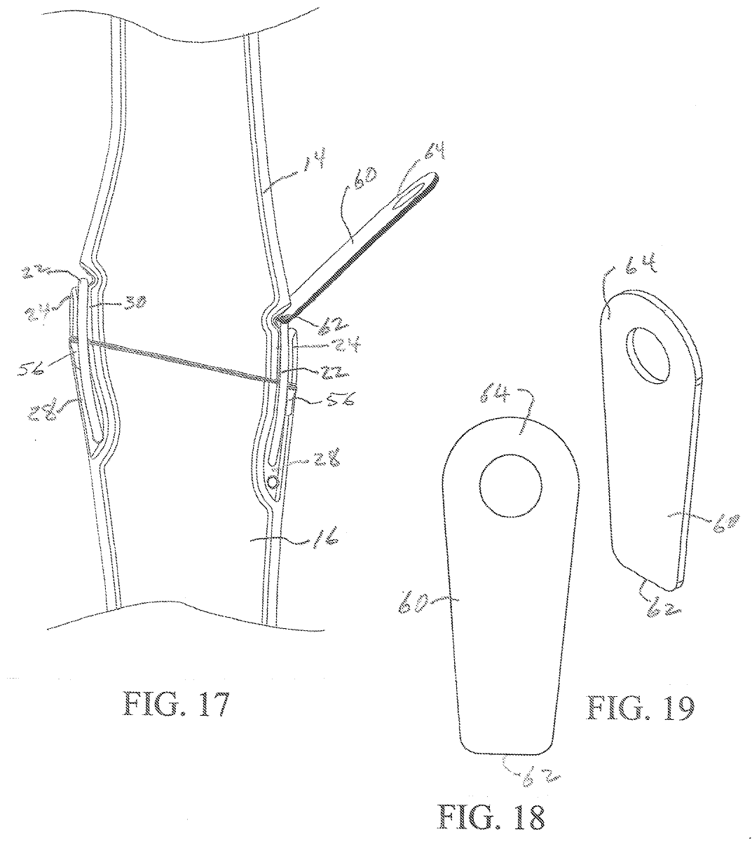

Regarding safety, the requirement to secure a wire clip 22 on each side of the axe handle provides a measure of safety redundancy with respect to unintended separation of the axe connection. Generally a user will be able to see if the wire clips are secured in the hatchet handle latches 24. However, sometimes although the extension handle may be fully inserted into the hatchet handle such that there is no gap between the mating surfaces, without looking carefully, if the clip is not fully pushed into the latch groove 32 but merely positioned closely against the latch, a user may not notice that the clip is not in latched position. To ensure that a user can notice if the wire clips are not fully latched, two precisely located clip nub protrusions 56, FIGS. 6, 7, 10 and 11, precisely located on each side of the top of the extension handle 16, will causes the wire clips to protrude significantly from axe handle if not latched, FIGS. 7, 8, and 10, and thus provide a visible and tactile warning that the handle connection is not fit for use until properly latched over the hatchet handle latch 24. To move the wire clips 22 into latched position, the clip will have to be pushed over the nub protrusions as well as over the latch 24 into the latch groove 32. The clips are designed to be placed in latched position by a user using one or two thumbs or using fingers. Once pushed over the nub protrusion 56 into latched position, the nub protrusion 56 will also further hold the wire clips in latched position. As a further safety consideration, when the wire clip 22 is pushed into latched position, it is very difficult for a user to pull the wire clip from latched position to unlatched position. To move the wire clip from latched position to unlatched position to thereby allow the separation of the handle extension from the hatchet handle, a clip extractor tool 60, FIGS. 17, 18, and 19, was designed. The extractor tool 60 is a rigid flat metal piece with a straight edge 62 at one end. The other end 64 serves as a handle. The straight metal edge 62 is inserted into the hatchet handle recess 30 between the hatchet handle and the top of the wire clip as shown in FIG. 17, and the handle end 64 is pushed upwardly to causes the wire clip 22 to naturally move out of the hatchet handle latch groove 32 and over both the hatchet handle latch 24 and the extension handle clip nubs 56, thereby allowing the extension handle 16 to be pulled from the hatchet handle 14 without wire clip interference. The handle connection can not be properly disassembled without the use of the extractor tool 60 to open the wire clips.

Traditionally, the gold standard material for axe handles is high-grade hickory wood. Hickory wood is very strong, durable and its long fibers minimizes impact vibrations. As well, hickory does not require regular oiling to avoid splintering over time like other hardwoods such as oak and cherry. Nevertheless, the contemplated handle connection design of this invention, precluded the use of any natural wood material. Given the significantly reduced cross sectional area of the hatchet handle, no natural wood handle has sufficient compressive or tensile strength to withstand the normal use of a forest axe. As well, to manufacture and market a competitively priced commercial axe product having a similar feel to natural wood, the use of carbon fiber composite material was ruled out. It was determined that a long-fiber reinforced thermoplastic material offered the best option to meet the strength, ergonomic, case-of-use, and cost of a commercial product. Accordingly, a long-fiber thermoplastic has been selected and optimized to balance strength vs. comfort (vibration), rigidity vs. flexibility and toughness vs. brittleness. As well, the mold flow has been optimized to create inline glass fiber orientation throughout the highest stress areas of the axe handle. A VLF (very long fiber) thermoplastic material such as made by RTP Company has been found satisfactory.

The inventors experimented with many handle sizes and shapes for the axe of the invention when operated first as a camp hatchet and then transformed into a forest axe. To this end, it was determined that the hatchet handle utilize a consistent oval cross-sectional shape which ergonomically fits within the hand but is also structurally strong enough to withstand all normal hatchet operations and that it is a hollow injection molded part which over molds onto the axe head. The belly of the hatchet handle is slightly curved down towards a knob or grip which acts as a stop for the for the user's hand when swinging the hatchet. After much hatchet testing in the performance of various precise camp woodworking activities, it was determined that the preferred length of the camp hatchet is about 14 inches; however, other lengths are possible. A width between the belly and throat of the hatchet handle of about 1.5 inches has been found satisfactory.

Regarding the forest axe, its full handle is created by connecting the extension handle into the bottom of the hollow hatchet handle as explained above. The extension handle smoothly transitions from the grip of the hatchet handle using the same ergonomic oval cross-sectional shape of the hatchet handle and continues down to its own faun foot knob. It was determined that for versatility, control and power for limbing trees and splitting wood, the preferred overall length of the forest axe is about 26 inches. Thereby the length of the extension handle from its attachment to the hatchet handle is about 12 inches. Nevertheless, other overall axe lengths are possible.

Finally, in terms of achieving an ergonomically acceptable overall axe handle for the forest axe, it is critical that the size of connection region or the ‘connection swell’ be minimized. With the adoption of recessed wire clips as the method to secure the connection, many different connection swell sizes were tested for strength and ergonomic feel. With each connection swell size change, it would inevitably involve testing different grades of long-fiber thermoplastic material until an acceptable connection swell size was finally established according to this invention. The increase in swell is minimizes with the connections and latches described so that the width of the handle at the swell is not over about 2.5 inches. The narrowest width between the belly and throat of the extension handle is about 1.6 inches midway along its length and the minimum width of the hatchet handle is about 1.5 inches. Therefore the increased width of the swell is not significant and has not been found to interfere with the use and feel of the axe. A hole 66 through the extension handle near the bottom of the throat side of the handle can be provided through which a lanyard, not shown, can be attached for hanging or otherwise holding the axe.

When designing the axe of the invention, the inventors reached out to the bushcraft and outdoor camping communities in order to establish the most important performance features required of a:
1) Camp Hatchet, and
2) Forest Axe.

With the axe of the invention, the axe head is the same when used as a camp hatchet or as a forest axe. Thus, the design of the axe head for use as either a camp hatchet or as a forest axe had to be optimized with respect to material, weight, and the shape.

When choosing the axe head material there are many considerations that can lead to a harder or softer grade of steel alloy: how easy is it to sharpen in the field, does the edge chip or fold, is it brittle or ductile? Carbon Steel has been found satisfactory and was chosen because it is right on the edge of what can be resharpened with hand tools but will also be hard enough to stand up to the most extreme conditions. The axe head of the invention is formed using a drop forge press from high carbon steel which has been cryogenically tempered to exhibit superior metal properties. For example, a 1055 carbon steel has been found satisfactory. Several surfaces and areas of the forged axe head receive a special machining process in order to increase thermoplastic's adhesion to the axe head. A black oxide finish is applied to inhibit corrosion and wear.

After much testing, an overall axe head weight of about 1.5 lbs (680 grams) was chosen—not too heavy to be used as a camp hatchet; but also, not too light so that splitting and heavier work with the forest axe was still efficient.

The shape of the axe head 12 required design features for each axe mode.

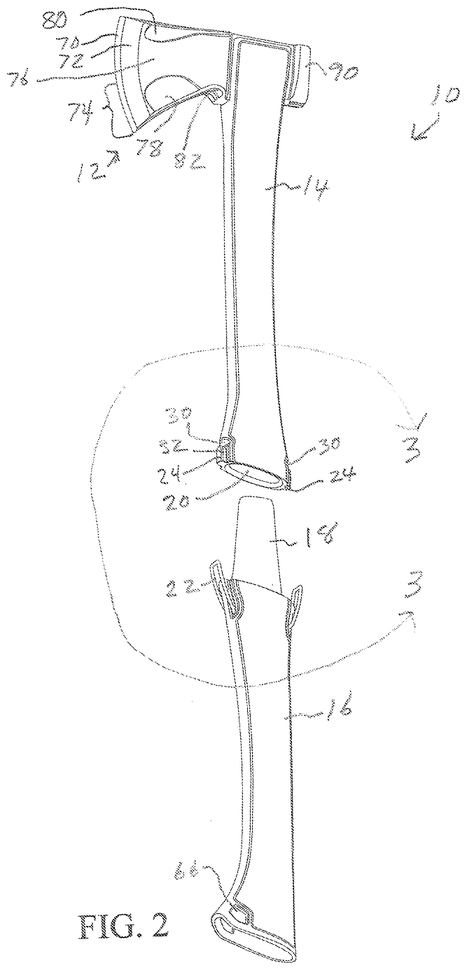

With respect to the cutting bit, many bit angles and styles were tested using fine and heavy wood processing activities. In order to provide a single axe head that could satisfactorily perform both as a hatchet and as axe, the inventors found that the axe head bit should include two bevels 70 and 72. The first bevel consists of about a 30-degree cutting edge 70 with a slight bevel which is very favourable for carving and detailed wood processing. This first bevel 70 transitions into about a 10-degree flat grind 72 allowing for superior initial penetration when splitting or limbing smaller trees. This two bevel design allows for precise control of the depth of cut when running along the grain of the wood while also slicing efficiently when cutting sideways through the wood grain. The beard 74 of the axe head drops low to protect the hand while choking up on the axe handle when performing smaller tasks when used as a hatchet. The low dropping beard 74 of the invention also protects the handle when splitting or chopping wood when used as an axe if the axe bit hits the wood lower than desired because the lower beard will generally still hit the wood rather than missing the wood which would result in the handle rather than the blade hitting the wood. The cheeks 76 of the axe head have two beveled relief cut-outs 78 near the toe and 80 near the heal of the axe head. This improves penetration and inhibits binding and sticking while splitting wood. Forest axes with mid-weight axe heads without this feature were observed during testing to bind easily and were often difficult to remove from logs. The relief cut-outs 78 and 80 also lower the overall weight of the axe head while keeping a large cutting edge. The axe head incorporates a smooth finger joint 82 on the front side and rounded poll or butt bottom 84 which is achieved through precise forging and post CNC machining—an improvement over many existing designs that put uncomfortable pressure on the hands and make longer tasks difficult. This ergonomic feature helps locate the user's hand properly and avoids fatigue when working on small camp tasks. The connection point or “eye” 86 of the axe head to the handle utilizes an over-molded function with a through connection or passage 88 within the axe head. Hatchet handle material passes through the X shaped cut-out 88 to create an extremely durable and resilient connection. With this over-moulding, the sides of the hatchet handle 14 extend over the sides of the axe head as shown, for example in FIG. 2. Finally, the poll or butt 90 of the axe head is hardened and flattened to create a usable surface for driving stakes or other various camp tasks.

Whereas the invention is here illustrated and described with reference to an embodiment thereof presently contemplated as the best mode of carrying out the invention in actual practice, it is to be understood that various changes may be made in adapting the invention to different embodiments without departing from the broader inventive concepts disclosed herein and comprehended by the claims that follow:

1. A two piece axe with a first piece forming a hatchet having a hatchet handle and a second piece forming an extension handle that when attached to the hatchet handle converts the hatchet into an axe, comprising:
a first piece comprising an axe head and a hatchet handle attached to the axe head and extending from the axe head to a hatchet handle attachment end spaced from the axe head, said axe head and attached hatchet handle forming a hatchet to be used as a hatchet, and said hatchet handle attachment end having a hatchet handle attachment end coupler for receiving and attaching an extension handle; and
a second piece comprising an extension handle with an extension handle attachment end having an extension handle attachment end coupler configured to mate with the hatchet handle attachment end coupler to attach the extension handle to the hatchet handle and thereby form a longer handle attached to the axe head to thereby form an axe to be used as an axe.

2. The two piece axe of claim 1, wherein the hatchet handle attachment end coupler includes a receiving opening in the attachment end of the hatchet handle, and a hatchet handle attachment end latch component, and wherein the extension handle attachment end coupler includes a tapered plug extending from the extension handle attachment end and configured to fit into the receiving opening of the hatchet handle, and an extension handle attachment end latch component configured to cooperate with the hatchet handle attachment end latch component to latch the extension handle to the hatchet handle.

3. The two piece axe of claim 2 wherein the hatchet handle attachment end latch component is a pair of spring wire clip latches and the extension handle attachment end latch component is a pair of spring clips rotatively attached to the extension handle near the extension handle attachment end to be rotated to extend beyond the extension handle attachment end and to be rotated to engage the clip latches on the hatchet handle attachment end to secure the handles together or to be rotated to disengage the clip latches to allow the handles to be separated.

4. The two piece axe of claim 3, wherein the hatchet handle and the extension handle are molded of a long fiber reinforced thermoplastic material.

5. The two piece axe of claim 4, wherein the extension handle has an outer surface and recesses are molded into the extension handle outer surface to provide room for the spring clips to be rotatively attached to the extension handle without extending beyond the outer surface of the extension handle when in locked position.

6. The two piece axe of claim 5, wherein the extension handle and the clips are configured to position ends of the clips beyond the outer surface of the extension handle when not positioned in locked position over the clip latches on the hatchet handle.

7. The two piece axe of claim 6, wherein the hatchet handle has an outer surface and recesses are molded into the hatchet handle outer surface around the clip latches on the hatchet handle to provide room for the spring clips when rotated over the clip latches into latching position to be secured to the clip latches without extending beyond the outer surface of the hatchet handle.

8. The two piece axe of claim 7, wherein the hatchet handle is over-molded over the axe head.

9. The two piece axe of claim 8, wherein the axe head includes an opening through the axe head in a location where the over molded hatchet handle covers the axe head so that hatchet handle material extends into and through the opening to further attach the handle to the axe head.

10. The two piece axe of claim 7, wherein the axe head includes a bit having a double bevel.

11. The two piece axe of claim 10, wherein the double bevel includes a first bevel forming a cutting edge along a bit edge of the axe head and a second bevel forming a flat transition surface from the first bevel to opposite cheeks of the axe head and wherein the second bevel forms a flat splitting surface.

12. The two piece axe of claim 11, wherein the axe head includes a toe and heel, and wherein the cheeks include beveled cutouts near the toe and heel of the axe head.

13. The two piece axe of claim 12, wherein the weight of the axe head is about 1.5 pounds.

14. The two piece axe of claim 1, wherein the axe head includes a bit having a double bevel.

15. The two piece axe of claim 14, wherein the double bevel includes a first bevel forming a cutting edge along a bit edge of the axe head and a second bevel forming a flat transition surface from the first bevel to opposite cheeks of the axe head and wherein the second bevel forms a flat splitting surface.

16. The two piece axe of claim 1, wherein the weight of the axe head is about 1.5 pounds.

17. A two piece axe with a first piece forming a hatchet and a second piece used as a hatchet handle extension that when attached to the hatchet handle converts the hatchet into an axe, comprising:
a first piece comprising an axe head, a hatchet handle attached to the axe head and extending from the axe head to a hatchet handle attachment end spaced from the axe head, and hatchet handle attachment means at the hatchet handle attachment end for attaching an attachment end of an extension handle to the attachment end of the hatchet handle; and
a second piece comprising an extension handle with an extension handle attachment end, and extension handle attachment means at the extension handle attachment end for attaching the attachment end of the extension handle to the attachment means of the hatchet handle to secure the hatchet handle and extension handles together.
